(19) United States
(12) Patent Application Publication
(10) Pub. No.: US 2010/0080286 A1
(43) Pub. Date: Apr. 1, 2010

(54) COMPRESSION-AWARE, VIDEO PRE-PROCESSOR WORKING WITH STANDARD VIDEO DECOMPRESSORS

(76) Inventor: Sunghoon Hong, San Diego, CA (US)

Correspondence Address: BOYLE FREDRICKSON S.C., 840 North Plankinton Avenue, MILWAUKEE, WI, 53203, US

(21) Appl. No.: 12/505,173

(22) Filed: Jul. 17, 2009

Related U.S. Application Data
(60) Provisional application No. 61/082,760, filed on Jul. 22, 2008.

(51) Int. Cl. H04N 7/26

(52) U.S. Cl. 375/240.02; 375/E07.126

(57) ABSTRACT

Video data is pre-processed to improve its compressibility by standard MPEG compressors for superior transmission at low data rates to standard devices. The pre-processor divides the video images into components selecting subsets of the components based on a buffer signal from the standard compressor.

### CROSS-REFERENCE TO RELATED APPLICATIONS

This application claims the benefit of U.S. provisional application 61/082,760 filed Jul. 22, 2008, hereby incorporated by reference.

### STATEMENT REGARDING FEDERALLY SPONSORED RESEARCH OR DEVELOPMENT

N/A

### BACKGROUND OF THE INVENTION

The present invention relates to data compression systems and, in particular, to a video compression system particularly useful at low data transmission rates.

The ability to transmit video images, for example, to mobile devices and in particular cell phones, relies largely on advances in video data compression technology. A video compression system developed by the Moving Picture Experts Group (MPEG), and in particular MPEG-4 standard, can be used to send video to low bit rate devices such as cellular phones with a transmission channel having a bandwidth as low as 64 kB per second.

Such video compression systems make use of the discrete cosine transform that converts pixels of a video frame (each pixel having a two-dimensional pixel location and three-color pixel value) into data in a frequency plane. For color images, the compression process may be performed independently for each of three-color channels. Henceforth only one channel will be described with it being understood that multiple channels may be processed similarly. A property of the cosine transform is that the majority of the visual information of the video frame is concentrated in a small corner of that frequency plane. A truncation of data values of the frequency plane outside of the corner combined with conventional variable length coding or other compression technique is thus used to reduce the amount of information necessary to reconstruct the video frame. Generally the amount of compression, for example dictated by the truncation threshold, can be changed to effect a trade-off between the amount of compression and the quality of the image.

Particularly for radio transmission, a desirable full utilization of the radio channel capacity requires that the irregular rate of compressed data (caused by the changing compressibility of any given video frame) be metered to a constant data rate equal to approximately the maximum channel capacity. This metering is accomplished through a buffer memory that serves as an accumulator to smooth data transmission rate between video frames of low compressibility and high compressibility. The rate of filling of the buffer may be monitored to control the compression factor implemented by the video compressor. Thus, if the buffer is filling too fast, increasingly aggressive compression may be adopted, while if the buffer is not being fully used, the compression rate may be decreased to permit better image quality. This process requires some care: if the buffer fills too soon, later data will be lost causing a dropping of video frames or other degradation.

The MPEG-4 compression system is popular and MPEG-4 compatible decoders are found in a large installed base of portable devices and, in particular, cell phones. Accordingly, MPEG type compression of video is a de facto standard for the transmission of video content, providing access to the widest variety and greatest number of devices.

### SUMMARY OF THE INVENTION

The present invention provides a pre-processor for an MPEG compressor that substantially improves the quality of the transmitted images at low data rates while still producing an encoded file that is fully compatible with standard MPEG decoders. The pre-processor of the present invention evaluates the operation of the MPEG encoder in compressing the video frames, adding additional compression when the MPEG encoder is overburdened and decreasing compression when the MPEG encoder is operating adequately. The pre-processor thus allows its own compression algorithms to be substituted for those of the MPEG encoder, particularly for low data rates, to improve low data rate compression while still producing MPEG compatible data.

Specifically, the present invention provides a video compression system having a standard compressor system receiving video frames and transmitting compressed video frames at a predetermined target bit rate. The standard compressor system is of a type such that it may receive raw video to produce compressed video decompressible with the standard decompressors of the receiving devices, and the standard compressor system further provides a dynamically varying compression rate changing to provide a predetermined average throughput of video frames to match the target bit rate. Positioned before the standard compressor is a pre-processor receiving raw video frames and providing prepared video frames to the standard compressor system, the pre-processor further using a measure of the compression rate of the standard compressor system to variably pre-compress the raw video frames so that higher compressibility is provided when the varying compression rate is higher and lower compressibility is provided when the varying compression rate is lower.

It is thus an object of the invention to provide a way of tailoring standard compression systems for extremely low data rates without the need for special decompression algorithms on an installed base of mobile devices.

The standard compressor and standard decompressor may be MPEG compliant.

It is thus an object of the invention to work with de facto globally standard compression systems.

The target bit rate is less than 100 kBs.

It is thus an object of the invention to adjust a pre-existing general-purpose standard for improved video transmission to low data rate mobile devices.

The pre-processor may divide the raw video frames into multiple components and change the compressibility of the raw video frames by selectively transmitting to the standard compressor different combinations of the multiple components.

It is thus an object of the invention to produce variable compressibility using a small number of static but optimized compression models.

The multiple components may include an approximation of the raw video frames using a limited set of pixel values.

It is thus an object of the invention to find compression by decreasing pixel value range, a quality that is believed to be visually less important for small screen displays of portable video devices.

The multiple components may include a residual value representing high order derivatives of the raw video frames.

It is thus an object of the invention to enhance its definition in highly compressed small screen displays beyond that anticipated by the MPEG model.

The high order derivatives may be obtained iteratively by repeated differentiation and normalization of the raw video frames according to an iteration number.

It is thus an object of the invention to provide a novel edge enhancement technique believed to be particularly suitable for small screen displays.

The iteration number may be functionally dependent on the measure of compression rate of the compressor.

It is an object of the invention, therefore, to permit the edge enhancement technique to be sparingly applied only as necessary.

The multiple components may further include information extracted exclusively from object edges in a video frame.

It is thus an object of the invention to not only enhance edges but to increase the data content at the visually important edges.

The multiple components may be ranked in the order of: (a) an approximation of a video frame using a limited set of pixel values; (b) information extracted exclusively from object edges in a video frame; and (c) a residual value representing high order derivatives of a video frame; and the components may be combined in their rank order to provide the variable compressibility of the raw video frames.

It is thus an object of the invention to provide an ordering of these techniques according to visual significance.

The measure of compression rate of the compressor may be derived from a schedule of filling of a buffer for transmission of the video frames or may be derived from a model by the pre-processor.

It is thus an object of the invention to permit tight integration of the pre-processor with the standard compressor even without access to the inner workings of the standard compressor.

These particular objects and advantages may apply to only some embodiments falling within the claims and thus do not define the scope of the invention.

### BRIEF DESCRIPTION OF THE FIGURES

FIG. 1 is a simplified block diagram of a standard MPEG compressor and decompressor showing implementation of a buffer for dynamically changing the compression rate Q;

FIG. 2 is a plot of buffer capacity as a function of time for the MPEG compressor of FIG. 1, showing normal buffer operation and a buffer overflow;

FIG. 3 is a block diagram similar to that of FIG. 1 showing the positioning of the pre-processor of the present invention before the standard compressor to monitor compression rate Q of the MPEG compressor;

FIG. 4 is a detailed block diagram of the pre-processor of FIG. 1 showing the decomposition of a video image into various components using a pixel level quantizer, a gradient processor, and an edge detector;

FIG. 5 is a detailed block diagram of the gradient extractor of FIG. 4;

FIG. 6 is a detailed block diagram of the pixel level quantizer of FIG. 4;

FIG. 7 is a data flow diagram of the edge extractor of FIG. 4;

FIG. 8 is a flow chart of the steps implemented by the compressor of the present invention;

FIG. 9 is a block diagram similar to that of FIG. 3 showing an alternative compressor/decompressor system providing improved performance but requiring a special decompressor at the user device;

FIG. 10 is a flowchart implemented by the edge extractor of FIG. 8.

### DETAILED DESCRIPTION OF THE PREFERRED EMBODIMENT

Referring now to FIG. 1, a standard MPEG compression system 10 may receive a series of raw video frames 12 at an MPEG compressor 14 to provide compressed output 16 to a buffer 18. The buffer 18 may provide data to a channel 20. The channel 20 may be, for example, a wireless transmission channel of a cell phone or other wireless device, a band-limited serial channel, or the input of a digital recording device requiring or benefiting from substantially constant data rates.

Data from the channel 20 may be sent to a receiving device 22, for example a mobile phone, having an MPEG decompressor 24 and producing reconstructed video frames 30 for display on a display device 31. Generally the MPEG compressor 14 and MPEG decompressor 24 are lossy compression system and reconstructed video frames 30 are therefore degraded with respect to raw video frames 12.

Referring still to FIG. 1, the MPEG compressor 14 may accept a signal indicating compression factor 32 (Q) and controlling an amount of compression implemented by the MPEG compressor 14. Change in the compression implemented by the MPEG compressor 14 is normally effected changing the truncation following the cosine transform or the variable length encoding. This compression factor 32 will be varied according to the fill rate of the buffer 18 to provide a substantially constant compressed data output into channel 20.

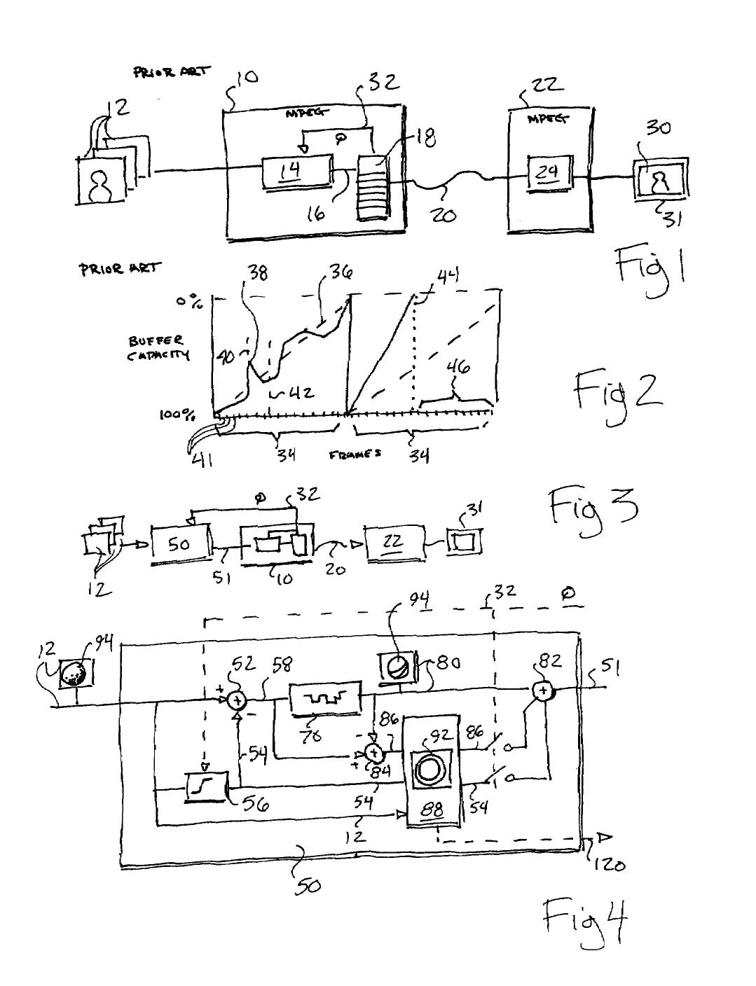

Referring now to FIG. 2, the buffer 18 may be filled and periodically emptied at a fill interval 34 or maybe continuously both filled and emptied on a dynamic basis to provide more constant output of data to channel 20. In the former case, the buffer capacity may be monitored during the fill interval 34 over successive video frames 41 and compared against a constant fill threshold 36 indicating a rate of buffer capacity change that exactly fills the buffer in a fill interval 34. The compression factor 32 may be adjusted according to whether the actual buffer capacity 38 is above or below the constant fill threshold 36. Thus, if the actual buffer capacity 38 at any given time 40 is less than that indicated by the constant fill threshold 36, the compression factor 32 may be increased to provide additional compression to bring the fill rate of the buffer down. Conversely at a time 42, when the actual buffer capacity 38 is greater than that indicated by the constant fill threshold 36, the compression factor 32 may be decreased making a trade-off toward better image quality and less compression.

As indicated by fill interval 34′, there can be a string of raw video frames 12 that even at the highest compression factor 32 rapidly fill the buffer exhausting the buffer capacity at time 44. In this case, succeeding video frames 46 will be dropped severely affecting the quality of the reconstructed video frames 30 and manifest as a freezing of the image during the dropped video frames 46.

Referring now to FIG. 3, the present invention inserts a pre-processor 50 that receives the raw video frames 12 and that is positioned before the standard MPEG compression system 10 to provide prepared video frames 51 to the standard MPEG compression system 10. The pre-processor 50 may read the compression factor 32 from the standard MPEG compression system 10 either by monitoring the buffer capacity directly, reading the compression factor 32 of the standard MPEG compression system 10, or modeling the value of the compression factor 32 through a model of the standard MPEG compression system 10. The compression factor 32 is then used to adjust the amount of compressibility the pre-processor 50 imparts to the prepared video frames 51 and, hence, the ability of the standard MPEG compression system 10 to compress the prepared video frames 51. Notably, in the first embodiment, because the output of the pre-processor 50 is video frames (pre-processed to be highly compressible) the use of the pre-processor 50 does not require a special decompressor at the receiving device 22 but the output of the MPEG compression system 10 can be fully processed by the standard MPEG decompressor 24.

The standard MPEG compression system 10 and/or the pre-processor 50 may be constructed separately or as a single unit and implemented in software executed on an electronic computer or by specialized integrated circuitry such as digital signal processors executing firmware according to techniques well known in the art.

Referring now to FIG. 4, the pre-processor 50 receives the raw video frames 12 and separates the raw video frames 12 into various components as will be described. Sets or subsets of these components may be selectively combined and sent to the standard MPEG compression system 10 in response to the compression factor 32 to provide a variable “boost” to the compression possible using the standard MPEG compression system 10.

In this regard, the raw video frames 12 are received by the pre-processor 50 at a summing node 52 and at a gradient processor 56. At summing node 52, high spatial frequency data 54 of the raw video frames 12 is extracted from the raw video frames 12 by subtracting the output of the gradient processor 56, as will be described, producing frequency modified data 58.

Referring now also to FIG. 5, the gradient processor 56 receives the raw video frames 12 into a buffer 60 and then provides this buffered data to a gradient processor 62 which extracts the gradient of the two-dimensional video image into a first x-direction gradient field 64 and a second y-direction gradient field 66. As will be understood in the art, the gradient field 64 is essentially a discrete partial differentiation of the video image of the buffer 60 along the x-direction and the gradient field 66 is a discrete partial differentiation of the image of the buffer 60 along the y-direction.

Each of these gradient fields 64 and 66 are de-weighted by a coefficient C calculated according to the following formula:

$$C = \frac{1}{1 + \sqrt{{I}_{xx}^{2} + {I}_{yy}^{2}}}$$

where Iₓₓ and I_{yy} are the values of the gradient fields 64 and 66 at corresponding points in the gradient fields 64 and 66. It will be understood, therefore, that generally this coefficient C normalizes the gradient fields 64 and 66 by the magnitude of the vector sum of the gradients.

The absolute value of the de-weighted gradient fields 64 and 66 are then extracted as indicated by block 68 and summed per summing node 71 to produce an image-like field which is returned to the buffer 60.

This process of taking gradients and recombining them as described above is repeated for a predetermined number of times to produce a high spatial frequency data 54 generally revealing high spatial frequency content data in the raw video frames 12. In one embodiment, the number of iterations of this process can be controlled by the compression factor 32 so that an increased number of iterations occur when the standard MPEG compression system 10 is operating at its highest compression factor and a reduced number of iterations occur when the compression factor of the standard MPEG compression system 10 is lowest.

It will be understood generally that the gradient processor 56 detects and accentuates abrupt spatial changes in the raw video frames 12. This high-frequency content which is difficult to compress is thus removed from the signal provided to the standard MPEG compression system 10.

In one embodiment, each iteration may involves four gradient operations.

Referring again to FIG. 4 and also to FIG. 6, as described, the high spatial frequency data 54 from the gradient processor 56 is subtracted from the raw video frames 12 to produce frequency modified data 58 that is next provided to the pixel level quantizer 70. As shown in FIG. 6, the pixel quantizer 70 receives the frequency modified data 58 and develops a pixel value histogram 72 indicating a frequency of pixels having each possible pixel value (for example 0-255 for one color). Pixel values indicate the brightness contribution of the color at a pixel location and may be distinguished from pixel locations themselves.

This histogram 72 is then analyzed to identify a limited number of peak pixel values 75 identified by local maxima of the pixel histogram 72. Those peak pixel values 75 are provided to a quantizer 76 which maps the pixel values of the frequency modified data 58 to the appropriate limited number of pixel values to produce quantized image data 80. It will be understood that this process yields a quantization that is not at regular ranges of pixel value (e.g. for example 0-20, 21-30, . . . ) but vary depending on the statistics of the given frequency modified data 58. The pixels having value proximity (as opposed to spatial proximity) to the peak pixels of local maxima of the pixel histogram 72 have their values changed to the values of the peak pixel values 75.

Referring again to FIG. 4, the quantized image data 80 is next provided to a multi-input summing node 82 whose output provides the prepared video frames 51 previously described with respect to FIG. 3.

As shown in FIG. 4, frequency modified data 58 from summing node 52 is also provided to a summing node 84 that subtracts the quantized image data 80 from the frequency modified data 58 to produce a quantized image data 86 representing the information extracted or removed by the quantizer 70. This quantized image data 86 is provided to an edge detector 88 whose operation will be described below. In this regard, edge detector 88 also receives the high spatial frequency data 54 representing high-frequency content removed from the raw video frames 12 and, for the purpose of detecting edges, receives the raw video frames 12 as well.

Referring still to FIG. 4, in operation, the edge detector 88 will create a mask 92 defining edges of objects 94 within the raw video frames 12 and will use this mask 92 to extract the quantized image data 86 and the high spatial frequency data 54, in the manner of a stencil, only at the edges of objects 94. The extracted quantized image data 86′ and extracted high spatial frequency data 54′ may be successively added into the summing node 82 to be combined with the quantized image data 80 at summing node 82. Operation of the edge detector 88 may make use of standard edge detection techniques to define an edge and to grow that edge to a strip of predefined width (typically one to two pixels on each side of the strip) providing the desired mask.

The number of elements forming the sum used to create the prepared video frames, as noted above, will be decided according to the compression factor 32. In a first mode, the prepared video frames 51 consist only the quantized image data 80; in a second mode, the prepared video frames 51 consist of quantized image data 80 plus the extracted quantized image data 86′; and in a third mode, the prepared video frames 51 include quantized image data 80 plus the extracted quantized image data 86′ plus the extracted high spatial frequency data 54′. The first mode is used when the highest compressibility is required and the third mode when the least compressibility is required. Even when all of the data of 80, 86′ and 54′ are used, it will be understood that the prepared video frames 51 are more compressible than the raw video frames 12 because the edge detector 88 removes portions of data 86 and 54 from the prepared video frames 51 even when data 86′ and 54′ are switched into the summing node.

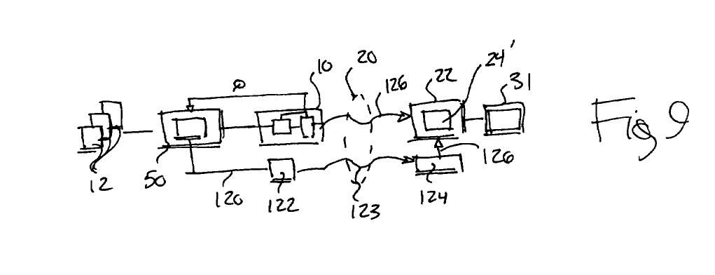

Referring now to FIG. 8, in overview it will be understood that the pre-processor 50 operates to divide the frame into multiple information components as indicated by process block 100. These information components are represented by the data 80, 86′, and 54′. Depending on the compression factor 32, as indicated by process block 102, high, medium or low compressibility is implemented by the pre-processor 50. In the event high compressibility is indicated by process block 104, quantized image data 80 is used alone. In the event medium compressibility is indicated by process block 106, data 80 and 86′ are used, and in the event that low compressibility is indicated, as depicted by process block 108, video frames 51 are assembled of data 80, 86′, and 54′. This combination is then forwarded to the standard MPEG compression system 10 as indicated by process block 110 and the process repeated for the next frame.

Referring now to FIG. 9 in a second embodiment of the invention, the pre-processor 50 may send edge data 120 separately to the remote device bypassing the pre-processor 50. The edge data, as will be described, is first passed through a compressor 122 to create augmenting data 123 that may be transmitted through channel 20 together with standard MPEG data 126. A special decompressor 124 receives the augmenting data 123 and provides it to a modified decompressor 24′ to supplement the MPEG data 126 received from standard MPEG compression system 10. This approach can provide extremely high quality images at low data rates but requires the special decompressors 124 on the receiving devices and thus is not compatible with many existing portable devices.

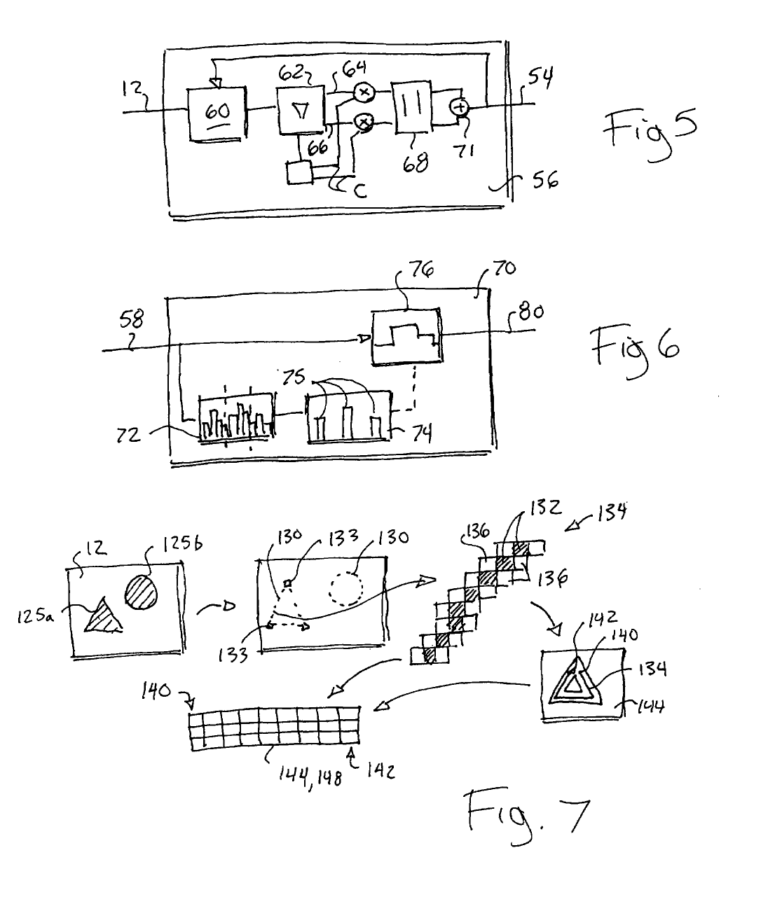

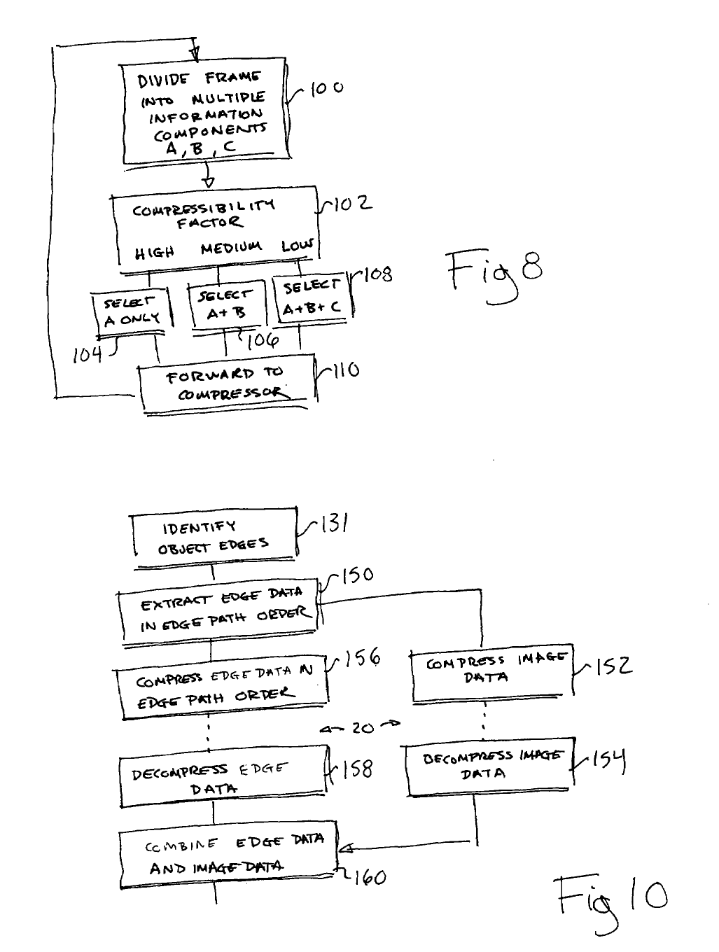

Referring now to FIGS. 7 and 11, the edge detector 88 described above, in this embodiment, receives the video frames 12 to first extract edges from objects 125a and 125b in the video frames 12, in the same manner as described above, using standard edge detecting algorithms. While two objects 125a and 125b are shown in this example, the number of objects and edges alternately detected need not be so limited.

This process, indicated by process block 131 results in the verification of a series of object edges 130 as may be defined by a string of ordered pixels listed as such, or by segment vertices 133. The edges 130 are widened to include a data swath 134 of additional pixels 136 on either side of the centerline pixels 132 and pixel locations of these pixels, as well as a starting point 140 and ending point 142 of the data swath 134 captured in a pixel position map 144. The information from the pixel position map 144 and from the data swath 134 are combined to form a regular vector 148 having a column order matching a traversal of the path of the data swath 134 from starting point 140 to ending point 142 as indicated by process block 150 of FIG. 10 and having a row order reflecting the order of pixels across the width of the path of the edges 130. Thus, this regular vector 148 contains not only pixel values but also pixel locations and their ordering along the path of edges 130.

As indicated by process block 152, the entire raw video frame 12 compressed by an arbitrary compression technique, for example such as MPEG 4, is then transmitted to the receiving device 22 and decoded as indicated by process block 154. Alternatively the edge information of the vector 148 may be removed from the raw video frame 12 prior to compression and transmission.

Separately the pixel values of the vector 148 are compressed as indicated by process block 156 with a compression order following the path of the edge 130. It is believed that this compression ordering takes advantage of the inherent structure of objects 125a and 125b to produce superior compression of this edge data in contrast, for example, to a raster ordering typically used. The compression may, for example, be any one dimensional compression system including, for example, a delta compression system transmitting only differences between adjacent pixels or run length encoding or the like. The compressed pixel values together with identification of their spatial coordinates (the latter of which may also be compressed by compressor 122) are then transmitted as augmenting data 123.

This compressed edge data of the vector 148 is then decompressed as indicated by process block 158 at the receiving device and then, as indicated by process block 160, is combined with the regular image data decompressed at process block 154. The present invention thus provides a means of transmitting visually important edge data in a highly efficient manner by encoding the data according to a traversal of a path defined by the edge.

The present invention has been described in terms of the preferred embodiment, and it is recognized that equivalents, alternatives, and modifications, aside from those expressly stated, are possible and within the scope of the appending claims.

I claim:

1. A video compression system for transmitting compressed video information to receiving devices having standard decompressors, the video compression system comprising:
a standard compressor system receiving video frames and transmitting compressed video frames at a predetermined target bit rate, the standard compressor system, when receiving raw video, producing compressed video decompressible with the standard decompressors of the receiving devices, the standard compressor system further having a dynamically varying compression rate changing to provide a predetermined average throughput of video frames to match the target bit rate;
a pre-processor receiving raw video frames and providing prepared video frames to the standard compressor system, the pre-processor further using a measure of the compression rate of the standard compressor system to variably prepare the raw video frames so that higher compressibility is provided in the prepared video frames when the varying compression rate is higher and lower compressibility is provided in the prepared video frames when the varying compression rate is lower.

2. The video compression system of claim 1 wherein the standard compressor and standard decompressor are MPEG compliant.

3. The video compression system of claim 1 wherein the target bit rate is less than 100 kbs.

4. The video compression system of claim 1 wherein the pre-processor divides the raw video frames into multiple components and changes the compressibility of the raw video frames by selectively transmitting to the standard compressor different combinations of the multiple components.

5. The video compression system of claim 4 wherein the multiple components include an approximation of the raw video frames using a limited set of pixel values.

6. The video compression system of claim 4 wherein the multiple components include a residual value representing high order derivatives of the raw video frames.

7. The video compression system of claim 6 wherein the high order derivatives are obtained iteratively by repeated differentiation and normalization of the raw video frames according to an iteration number.

8. The video compression system of claim 7 wherein the iteration number is functionally dependent on the measure of compression rate of the standard compressor.

9. The video compression system of claim 4 wherein the multiple components include information extracted exclusively from object edges in a video frame.

10. The video compression system of claim 4 wherein the multiple components include, in the following rank order:
(a) an approximation of a video frame using a limited set of pixel values;
(b) information extracted exclusively from object edges in a video frame;
(c) a residual value representing high order derivatives of a video frame;
and wherein the components are combined in the rank order to provide variable compressibility of the raw video frames.

11. The video compression system of claim 1 wherein the measure of compression rate of the standard compressor is derived from a schedule of filling of a buffer for transmission of the video frames.

12. The video compression system of claim 1 wherein the measure of compression rate of the standard compressor is modeled by the pre-processor.

13. A video compression system for transmitting compressed video information to receiving devices having standard MPEG decompressors, the compression system comprising:
a standard MPEG compressor system receiving video frames and transmitting MPEG compressed video frames at a predetermined target bit rate; and
a pre-processor receiving raw video frames and approximating the raw video frames with approximated frames having a reduced number of pixel values and providing the approximated frames to the MPEG compressor as video frames.

14. A video compression circuit for transmitting compressed video information comprising:
an edge detection unit detecting edges of image objects in a series of video frames;
an edge extraction unit extracting data from the detected edges;
a compressor compressing the data of the detected edges in order of a traversal of a path following the edges to provide compressed edge data; and
an output circuit outputting the compressed edge data and path information describing spatial position of path.

15. The video compression circuit of claim 14 further including an image residual calculator extracting the edge data from the video frames to provide edge deemphasized frames and wherein the output circuit further outputs the edge deemphasized frames.

16. The video compression circuit of claim 14 further including a second compressor compressing the edge-deemphasized frames before outputting.

17. The video compression circuit of claim 16 wherein the compressor is an MPEG type compressor.

18. The video compression circuit of claim 14 wherein the edge data includes pixels defining an edge of an object and pixels within a predetermined width on each side of the pixels defining the edge of the object.

19. The video compression circuit of claim 14 wherein the data of the detected edges is residual data at the detected edges, being a difference between the video image and a compression of the video image limiting a number of pixel values.

20. The video compression circuit of claim 14 wherein the edge data is residual data at the detected edges being a difference between the video image and frequency limited data of the video image.

21. The video compression circuit of claim 14 wherein the output circuit is selected from the group consisting of a wireless transmitter, serial communication network, or a digital recording device.

22. The video compression circuit of claim 14 further including a decompressor receiving the compressed edge data and the path information to reconstruct the edge data.
